(19) United States
(12) Patent Application Publication
(10) Pub. No.: US 2020/0346108 A1
(43) Pub. Date: Nov. 5, 2020

(54) VIRTUAL REALITY FIREARM SIMULATION ACCESSORY

(71) Applicant: Bret Jason BLACKBURN, Carmichael, CA (US)

(72) Inventor: Bret Jason BLACKBURN, Carmichael, CA (US)

(21) Appl. No.: 16/809,323

(22) Filed: Mar. 4, 2020

Related U.S. Application Data
(60) Provisional application No. 62/813,762, filed on Mar. 5, 2019.

(51) Int. Cl. A63F 13/245; G09B 9/00; A63F 13/837; G06F 3/01

(52) U.S. Cl. CPC A63F 13/245; G09B 9/003; A63F 13/837; A63F 2300/1043; A63F 2300/8082; A63F 2300/8076; G06F 3/011

(57) ABSTRACT

A virtual reality firearm simulation accessory is disclosed. Example embodiments include: a virtual reality firearm simulation accessory comprising: a receiver including a first attachment mechanism for attaching a main hand virtual reality (VR) controller; a multi-barrel component attachable to a forward end of the receiver, the multi-barrel component including a second attachment mechanism for attaching an off-hand VR controller; and a buttstock attachable to a back end of the receiver.

### PRIORITY PATENT APPLICATION

This non-provisional patent application draws priority from U.S. provisional patent application Ser. No. 62/813,762; filed Mar. 5, 2019. This present non-provisional patent application draws priority from the referenced patent application. The entire disclosure of the referenced patent application is considered part of the disclosure of the present application and is hereby incorporated by reference herein in its entirety.

### COPYRIGHT

A portion of the disclosure of this patent document contains material that is subject to copyright protection. The copyright owner has no objection to the facsimile reproduction of the patent document or the patent disclosure, as it appears in the U.S. Patent and Trademark Office patent files or records, but otherwise reserves all copyright rights whatsoever. The following notice applies to the disclosure provided herein and to the drawings that form a part of this document: Copyright 2018-2020, Bret Jason BLACKBURN; All Rights Reserved.

### TECHNICAL FIELD

The disclosed subject matter relates to virtual reality gaming accessories or virtual reality training accessories, and more particularly to accessories to assist people who will be simulating using firearms and utilizing existing virtual reality controllers for their virtual reality experience.

### BACKGROUND

Virtual, augmented or mixed reality is a form of computer generated simulation that utilizes, but is not limited to, a motion tracked headset or glasses accompanied with motion tracked hand held controllers to immerse a person in a full 360 degree digital environment and allow them to interact with the environment by using the supplied headset and controllers. While in a virtual reality (VR) environment, a person can do anything that the VR software program running the VR simulation is programmed to do. They can fly, drive cars, explore other worlds, have super powers, roam with dinosaurs, travel through time, etc.; the possibilities are limited only to the imagination of those who made the simulation. In cases of VR games or training simulations that require a person to shoot a simulated firearm such as, but not limited to, a rifle, shotgun, sniper rifle, submachine gun, automatic firearm, etc., a player generally must hold the controllers in the air in such a way that mimics holding the firearm with one hand in front of the other and looking down the sights or a scope of a firearm. There is a need for a device that allows for a solid three point stability system of the shoulder, main hand, and off-hand to control a firearm in a VR simulation. Certain devices have been developed to help meet this need; but, these systems suffer many drawbacks that hinder the user's VR experience resulting in VR programs that are not utilized to their full potential. For example, these VR experience drawbacks include, but are not limited to, poor VR hand controller placement, limited adjustability, limited flexibility for independent hand control, limited adaptability for usage with currently existing VR hand controllers, and the like. Therefore, a need exists in the field for novel VR firearm simulation accessories capable of providing solid stabilization and independent hand flexibility that can also utilize currently available VR hand controllers.

### SUMMARY

There is disclosed herein various example embodiments of a virtual reality gaming accessory or virtual reality training accessory. In the various example embodiments described herein, there is disclosed a modular, adjustable, and customizable frame simulating a rifle style appearance comprised of multiple components including, but not limited to, a receiver, butt-stock, barrels or fore-ends, bi-pod, chin rest, rails, and several extensions and adapters. The components allow a person to easily attach currently existing VR hand controllers, such as but not limited to, HTC Vive™, HTC Vive™ Pro, HTC Cosmo™, Oculus Rift™, Oculus Rift™ S, Oculus Quest™, Windows™ mixed reality, Playstation VR™, etc. using a disclosed snap-in, wedge, or slide-in design. The components disclosed herein provide users with full three point stability with the shoulder, left hand, and right hand. The disclosed example embodiments, while supplying three point stability, also allow a user to have full ability to effortlessly detach the “off-hand” (denoted herein as the hand controller associated with holding the front of a firearm) controller to be able to interact with items in a VR simulated program like, but not limited to, doors, windows, throwable objects, reloading ammunition, etc. This ability to detach the off-hand controller provides users with full mobility enabling use of both hands independently as well.

An example embodiment includes: a virtual reality firearm simulation accessory comprising: a receiver including a first attachment mechanism for attaching a main hand virtual reality (VR) controller with a snap-in style VR controller attachment mechanism that does not obstruct the infrared sensors of the VR controller; a multi-barrel component attachable to a forward end of the receiver, the multi-barrel component including a second attachment mechanism for attaching an off-hand VR controller and providing stabilization and flexibility for the off-hand VR controller; and a buttstock attachable to a back end of the receiver. The example embodiments also include a cage barrel component attachable to a forward end of the receiver, the cage barrel component including a second attachment mechanism for attaching an off-hand VR controller and providing stabilization and flexibility for the off-hand VR controller. The example embodiments also include multiple modular components that can be arranged in various ways by a user to suit the needs of any particular VR simulation with currently existing VR hand controllers. The various example embodiments are described in more detail below.

### BRIEF DESCRIPTION OF THE DRAWINGS

Embodiments are illustrated by way of example and not limitation in the figures of the accompanying drawings, in which:

FIG. 1 illustrates an assembled example embodiment in one of many assembly versions showing all available parts without VR hand controllers;

FIG. 2 illustrates an assembled example embodiment in one of many assembly versions showing some of the available parts with VR hand controllers in a stock position;

FIG. 3 illustrates an assembled example embodiment in one of many assembly versions showing some of the available parts with VR hand controllers in an extended position;

FIG. 4 illustrates an assembled example embodiment in one of many assembly versions showing some of the available parts with one of the VR hand controllers in a folded position;

FIG. 5 illustrates an assembled example embodiment in one of many assembly versions showing some of the available parts with one of the VR hand controllers attached with an alternate cage barrel component option;

FIG. 6 illustrates an exploded view of an example embodiment;

FIG. 7 illustrates a prior art VR hand controller with the hand of a user showing how the controller is held;

FIG. 8 illustrates an exploded view of a set of parts of an example embodiment with function diagrams showing movement of parts consisting of sliding, adjusting, rotating, swapping, installing, or removing actions;

FIG. 9 illustrates examples of some conventional VR controllers used and listed as 132-A1-style, 162-B2-style, 164-C3-style, 166-D4-style, and 168-E5-style;

FIG. 10 illustrates an exploded rear view of a set of parts of an example embodiment;

FIG. 11 illustrates an exploded bottom view of a set of parts of an example embodiment;

FIG. 12 illustrates an exploded front view of a set of parts of an example embodiment;

FIG. 13 illustrates an exploded left side view of a set of parts of an example embodiment;

FIG. 14 illustrates an exploded right side view of a set of parts of an example embodiment;

FIG. 15 illustrates an exploded top view of a set of parts of an example embodiment;

FIG. 16 illustrates an embodiment of an assembly in one of many versions with some of the parts of an example embodiment used in combination with conventional D4-style VR controllers;

FIG. 17 illustrates an embodiment of an assembly in one of many versions with some of the parts of an example embodiment used in combination with conventional C3-style VR controllers;

FIG. 18 illustrates an embodiment of an assembly in one of many versions with some of the parts of an example embodiment used in combination with conventional C3-style VR controllers;

FIG. 19 illustrates an embodiment of an assembly in one of many versions with some of the parts of an example embodiment used in combination with conventional E5-style VR controllers;

FIG. 20 illustrates an embodiment of an assembly in one of many versions with some of the parts of an example embodiment used in combination with conventional B2-style VR controllers;

FIG. 21 illustrates an embodiment of an assembly in one of many versions with some of the parts of an example embodiment used in combination with conventional A1-style VR controllers;

FIG. 22 illustrates an embodiment of an assembly in one of many versions with some of the parts of an example embodiment used in combination with conventional A1-style VR controllers; and

FIG. 23 illustrates a drawing of off-hand attachments and intended operation with fore-end cage components.

### DETAILED DESCRIPTION

In the following detailed description, reference is made to the accompanying drawings that form a part hereof, and in which are shown, by way of illustration, specific embodiments in which the disclosed subject matter can be practiced. It is understood that other embodiments may be utilized and structural changes may be made without departing from the scope of the disclosed subject matter.

There is disclosed herein various example embodiments of a virtual reality gaming accessory or virtual reality training accessory. The example embodiments are comprised of multiple components that can be assembled in various ways and orderings to accommodate multiple VR programs or simulations and use of currently existing VR hand controllers. The virtual reality gaming accessory or virtual reality training accessory allows a user to have the three point stability of a simulated rifle as well as the ability of full two hand controller independence.

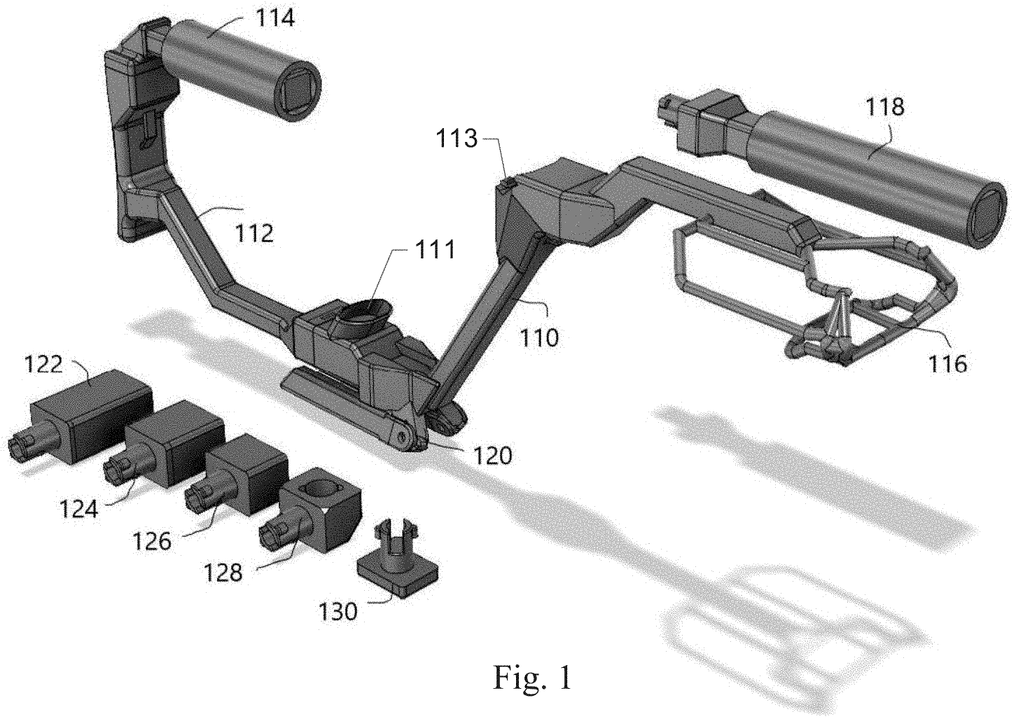

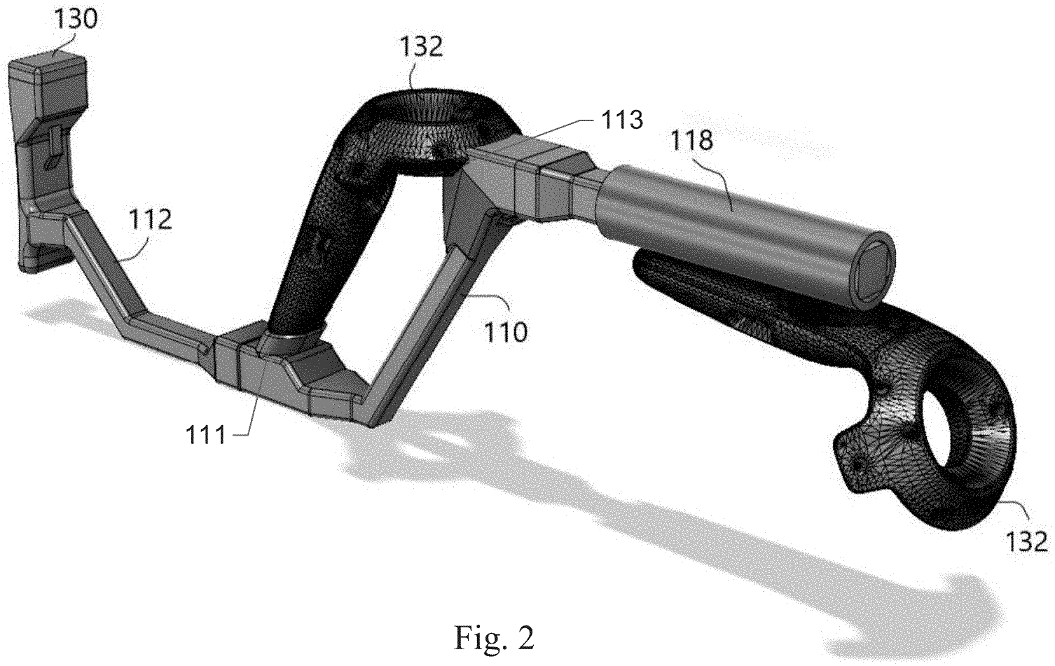

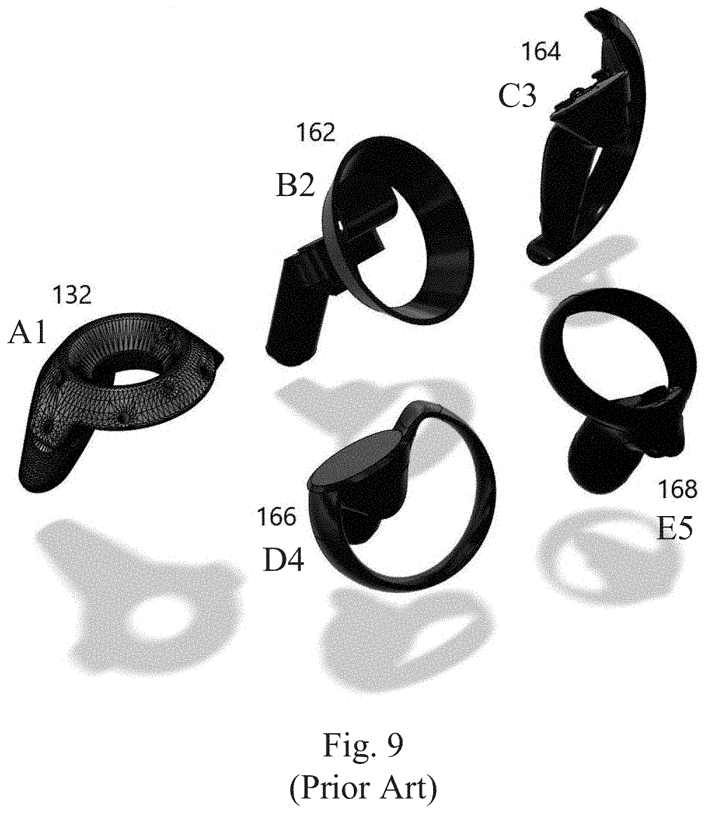

FIG. 1 illustrates an assembled example embodiment in one of many assembly versions showing all available parts without VR hand controllers. FIG. 2 illustrates an assembled example embodiment in one of many assembly versions showing some of the available parts with VR hand controllers 132 in a stock position. The various assembly versions represent a modular system including multiple interlocking pieces for customization. As shown in FIG. 2, the receiver 110 holds the main hand controller 132 with a snap-in, wedge, or slide-in style attachment 113, locking the main hand controller 132 in place without the need for any kind of securing device such as, but not limited to, a strap, bolt, clamp, screw, etc. (see also FIGS. 9 through 16). A hand controller support element 111 provides support for a lower end of the VR hand controller 132 as shown in FIG. 2. While secured in the receiver 110, none of the many infrared sensors on the VR controller 132 that track the motion of the controller are obstructed. As a result, the VR controller 132 is completely visible to the VR system.

Referring again to FIG. 2, using a locking system, any of the other components like the buttstock 112, bipod 120, multi-barrel 118, cage barrel 116, or any of the extensions or adapters 122, 124, 126, and 128 can attach to the receiver 110 to make the desired rifle style shape configurable as seen fit by the user. The bipod 120 can be attached to the lower forward end of the receiver 110 to simulate a support or rest to stabilize the assembly version on a surface.

As shown in FIG. 2, one variation of components can be connected together to make a common style of rifle used in some VR simulations. This assembly version includes the receiver 110, the attached main hand VR controller 132, the buttstock 112 removably attachable to the back end of the receiver 110, and the buttstock plug 130 used to cover the lock mechanism when the chin rest 114 is not used. The chin rest 114 is shown in FIG. 1. The assembly version shown in FIG. 2 includes the multi-barrel 118 removably attachable to a forward end of the receiver 110. The multi-barrel 118 can be covered with a round piece of tube foam for VR controller protection. The off-hand VR controller 132 can be removably attached to the multi-barrel 118 or held in place against the multi-barrel 118 and used in a standard position with the attached off-hand VR controller 132 as shown in FIG. 2.

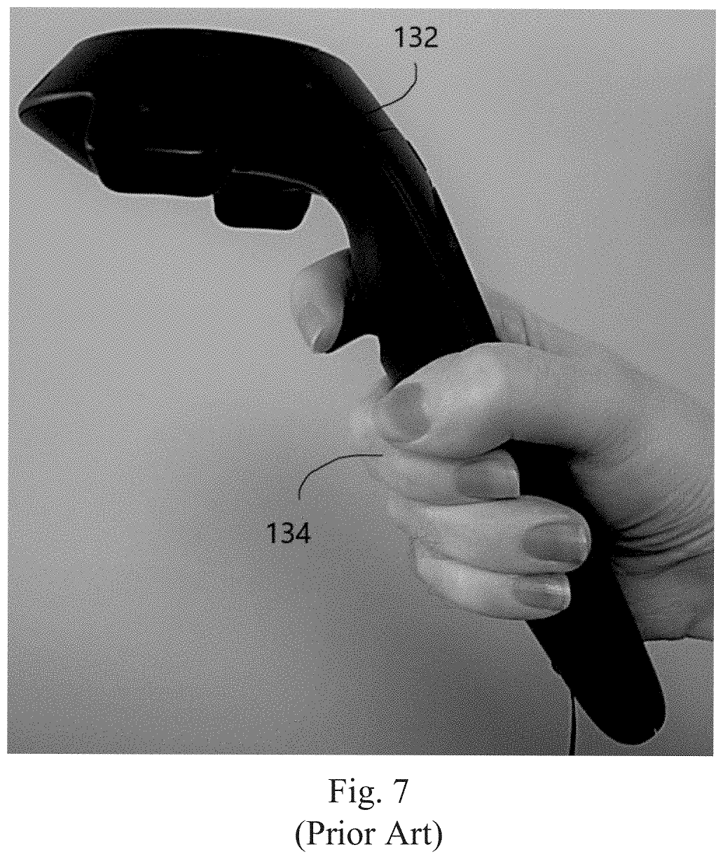

In the assembly version shown in FIG. 2, the user can hold the VR controller 132 with their off-hand 134 as shown in FIG. 7 and is able to hold the off-hand VR controller 132 and grab the multi-barrel 118 simultaneously to stabilize the assembly version like a gun. Additionally, the user can also remove the off-hand VR controller 132 from the multi-barrel 118 at any time to interact with other environmental or virtual objects within a VR simulation program.

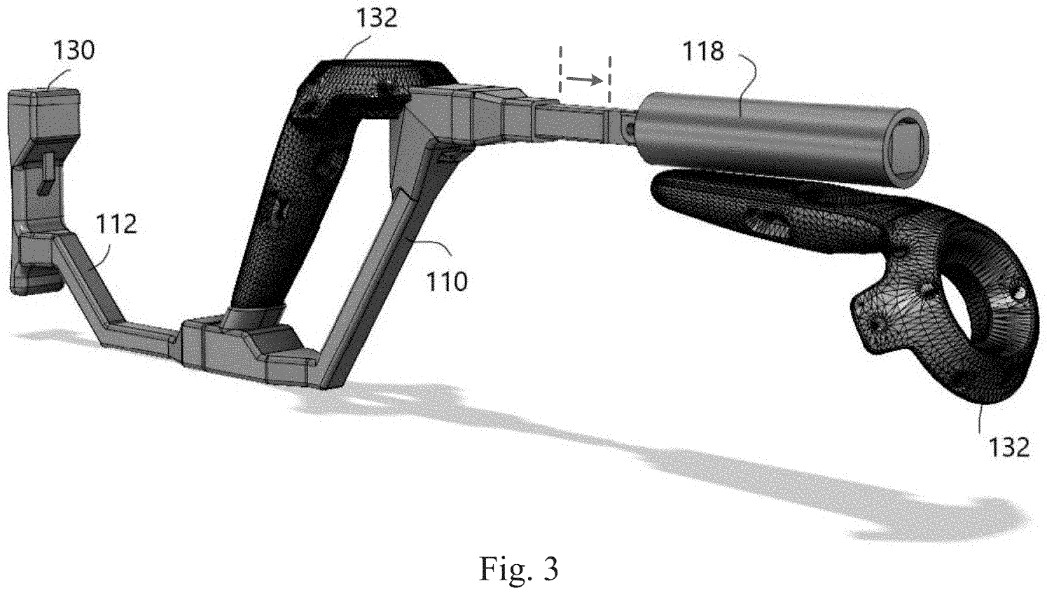

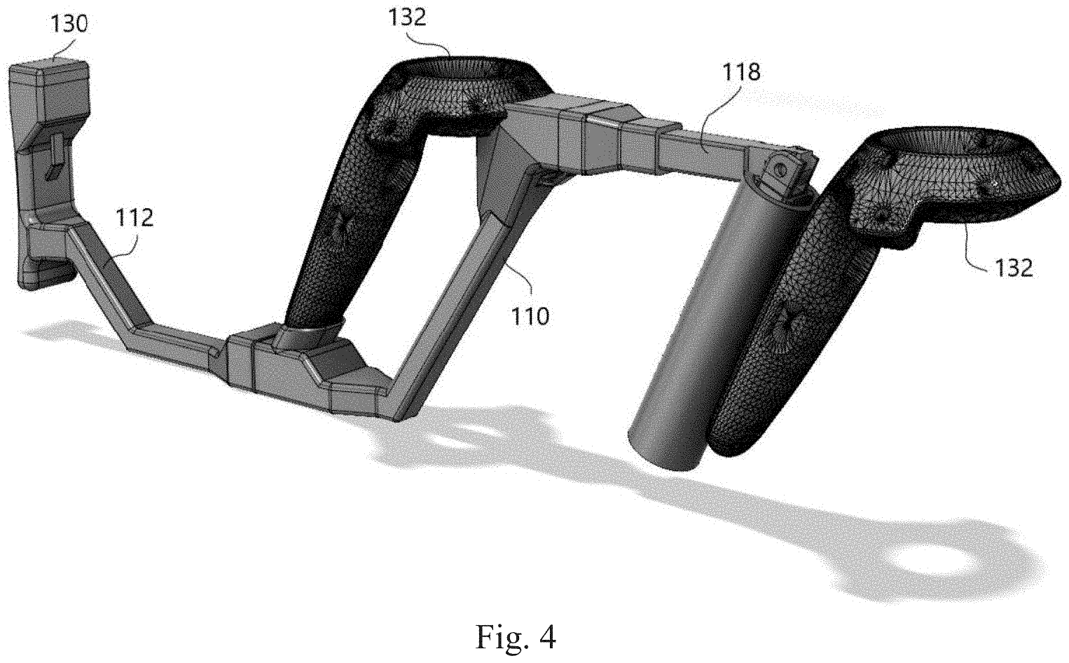

FIG. 3 illustrates an assembled example embodiment in one of many assembly versions showing some of the available parts with VR hand controllers in an extended position. FIG. 4 illustrates an assembled example embodiment in one of many assembly versions showing some of the available parts with one of the VR hand controllers in a folded position. In a manner similar to the embodiment shown in FIG. 2 and described above, the embodiments shown in FIGS. 3 and 4 also enable the user to hold the off-hand VR controller 132 and grab the multi-barrel 118 simultaneously to stabilize the assembly version like a gun. In other words, the user can utilize the same barrel grabbing technique as described for FIG. 2, except in FIG. 3, the multi-barrel 118 extends out horizontally for a longer grab point on a simulated weapon such as, but not limited to a hunting rifle, a sniper rifle or other long gun. When the multi-barrel 118 is extended as shown in FIG. 3, a greater distance is created between the main hand VR controller and the off-hand VR controller. For the assembly version shown in FIG. 4, the multi-barrel 118 folds downward and allows the user to grab the multi-barrel 118 simultaneously with the off-hand VR controller 132 in a vertical configuration to stabilize the assembly version like a weapon with an under barrel attachment, such as but not limited to, a vertical grip.

The example embodiments also enable the user to move the position of the multi-barrel 118, forward and back (extended and retracted), to simulate a sliding motion similar to a pump style shotgun for reloading a weapon in VR simulations that require such a motion. For example, FIG. 2 illustrates an assembled example embodiment with the position of the multi-barrel 118 in a non-extended position. FIG. 3 illustrates an assembled example embodiment with the position of the multi-barrel 118 in an extended position. The user can move the multi-barrel 118 forward and backward from the extended to non-extended position and back to simulate the sliding motion of a pump style shotgun.

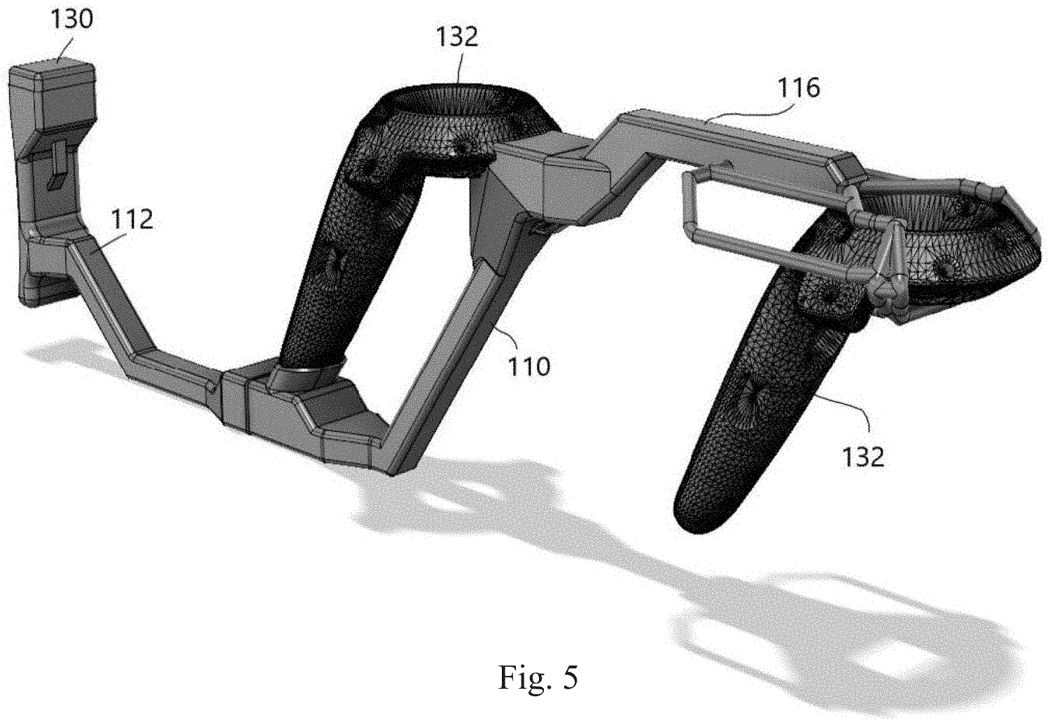

FIG. 5 illustrates an assembled example embodiment in one of many assembly versions showing some of the available parts with one of the VR hand controllers attached with an alternate cage barrel component option. FIG. 5 is another variant of components connected together in a configuration that utilizes the cage barrel 116 to allow a user to insert a VR controller 132 into the cage barrel 116 with a sliding motion. The cage barrel 116 retains the VR controller 132 in place and enables the user to remove their hand completely from the VR controller 132 while the VR controller 132 stays secure in the cage barrel 116. The cage barrel 116 provides a small amount of clamping force built into the cage barrel 116 to retain the VR controller 132 therein. The cage barrel 116 is configured so the body of the cage barrel 116 does not cover any of the motion sensors on the VR controller 132 while the VR controller 132 is inserted into the cage barrel 116. The VR controller 132 can be inserted into the cage barrel 116 or removed from the cage barrel 116 by sliding the VR controller 132 in or out.

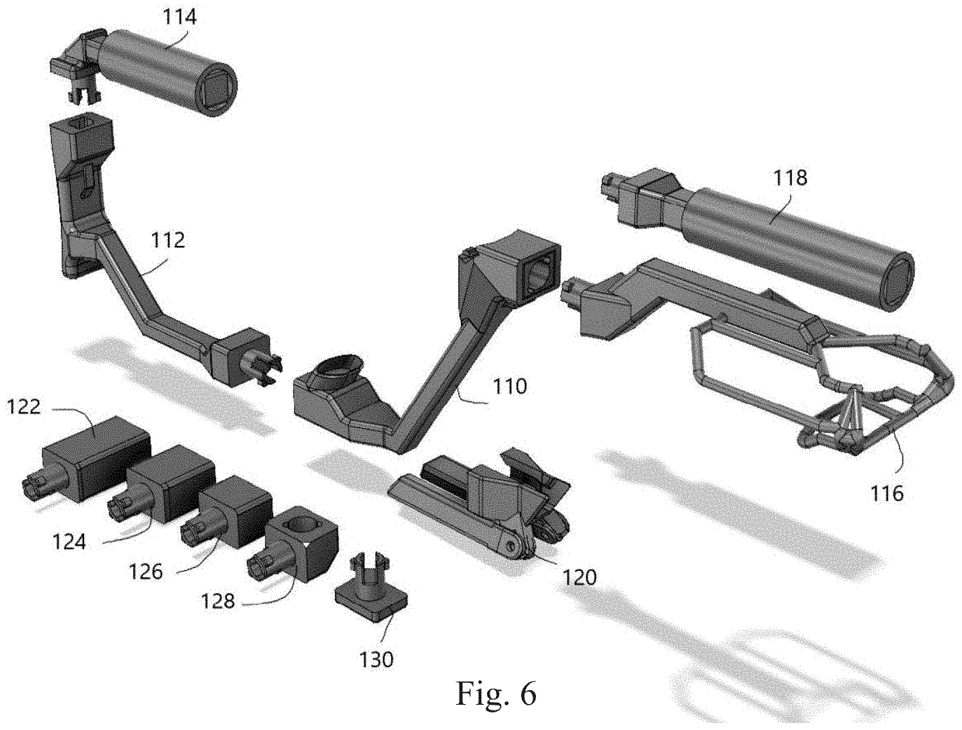

FIG. 6 is an exploded view of the components that comprise an example embodiment. As described above, the illustrated components can be assembled in a variety of ways to achieve a particular result desired by a user. The extensions and adapters 122, 124, 126, 128, and 130 are components that can be used to extend any component from the receiver 110 or otherwise configure the assembly version for personal preference by the user. As illustrated in FIG. 6, the elements shown include: receiver 110, buttstock 112, chin rest 114, cage barrel 116, multi-barrel 118, bipod 120, large extension 122, medium extension 124, small extension 126, 90-degree adapter 128, and buttstock plug 130.

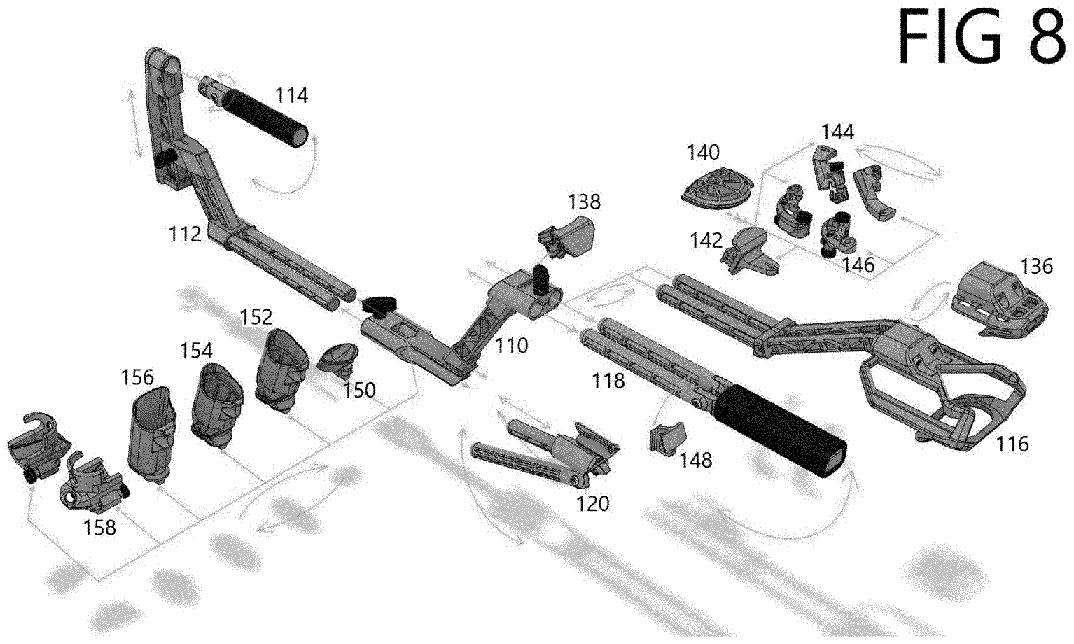

FIG. 8 illustrates an exploded view of a set of parts of an example embodiment with arrows showing movement of parts including sliding, adjusting, rotating, swapping, installing, or removing actions as described above. As shown in FIG. 8, the set of parts of an example embodiment can include receiver 110, buttstock 112, chin rest 114, cage barrel 116, multi-barrel 118, bipod 120, an alternate cage 136, an alternate cage plate for an off-hand VR controller lock 140, and a multi-barrel lock 148. The remaining parts shown in FIG. 8 are described below.

FIG. 9 illustrates examples of some conventional VR controllers used and shown as A1-style VR controller 132, B2-style VR controller 162, C3-style VR controller 164, D4-style VR controller 166, and E5-style VR controller 168. Any of these conventional VR controllers can be used with the various example embodiments as disclosed and illustrated herein.

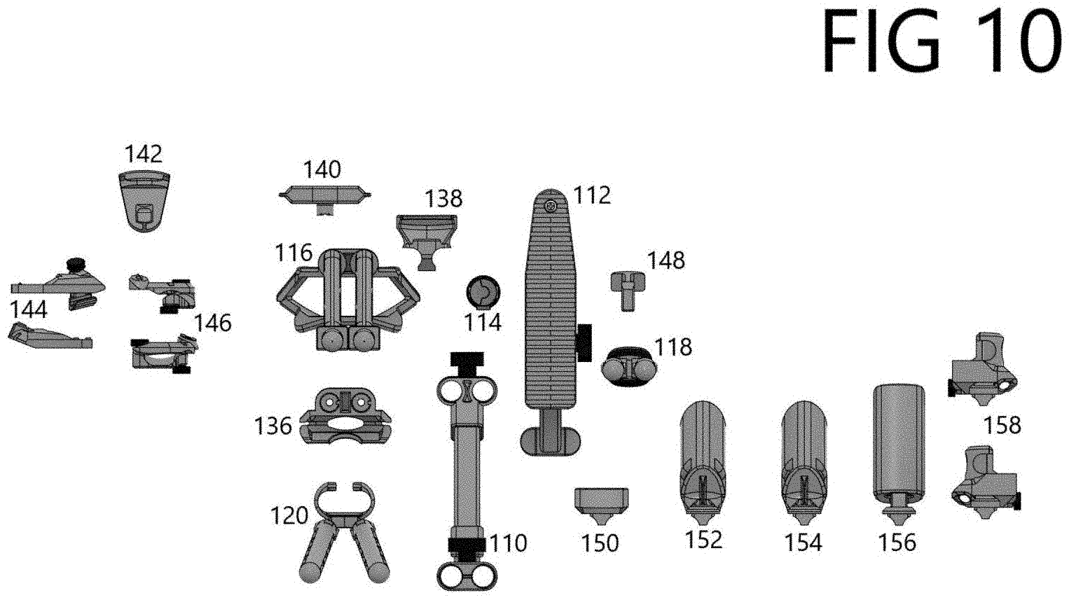

FIG. 10 illustrates an exploded rear view of a set of parts of an example embodiment. As shown in FIG. 10, the set of parts of an example embodiment can include receiver 110, buttstock 112, chin rest 114, cage barrel 116, multi-barrel 118, bipod 120, an alternate cage 136, an alternate cage plate for an off-hand VR controller lock 140, and a multi-barrel lock 148. The set of parts of an example embodiment shown in FIG. 10 can also include a main hand upper mount 138 for an A1-style VR controller 132, an alternate cage plate mount 142 for an E5-style off-hand VR controller 168, alternate cage plate mounts 144, left and right hand, for a C3-style off-hand VR controller 164, and alternate cage plate mounts 146, and left and right hand, for a D4-style off-hand VR controller 166. The set of parts of an example embodiment shown in FIG. 10 can also include a lower main hand mount 150 for an A1-style VR controller 132, a main hand mount 152 for a D4-style VR controller 166, a main hand mount 154 for an E5-style VR controller 168, a main hand mount 156 for a B2-style VR controller 162, and a main hand mount 158, left and right hand, for a C3-style VR controller.

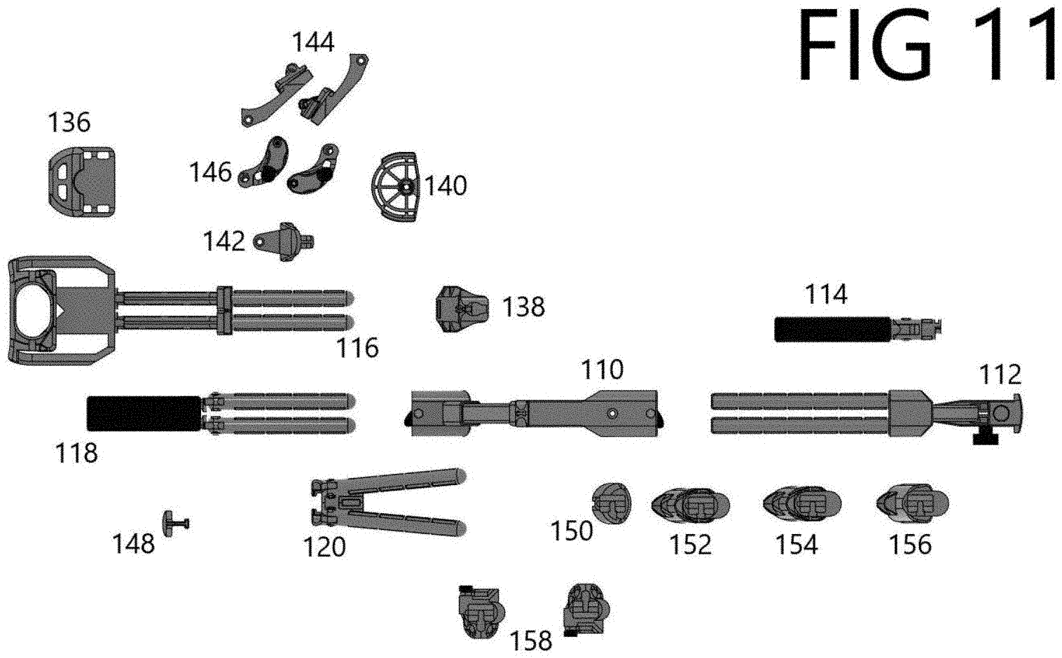

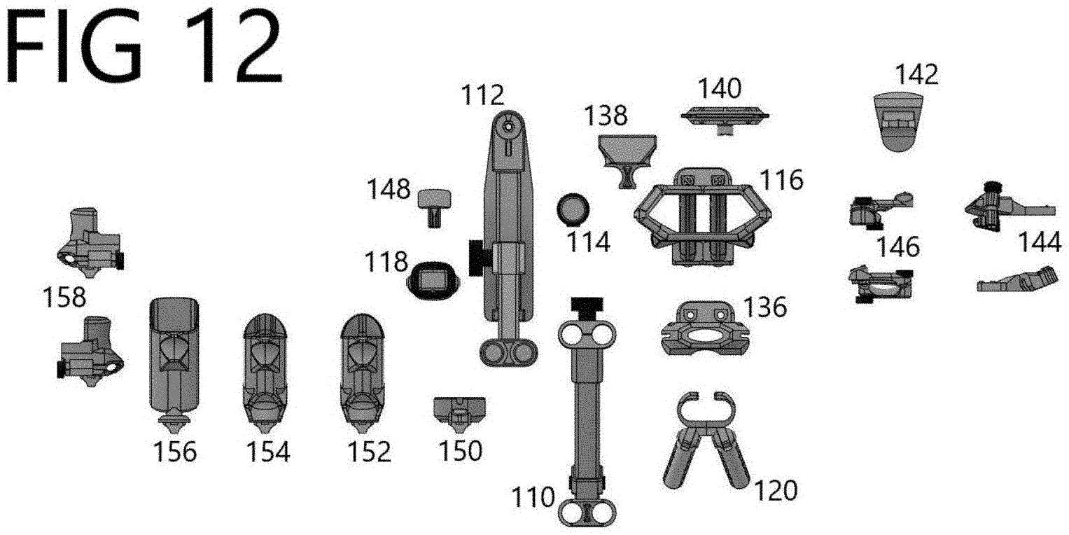

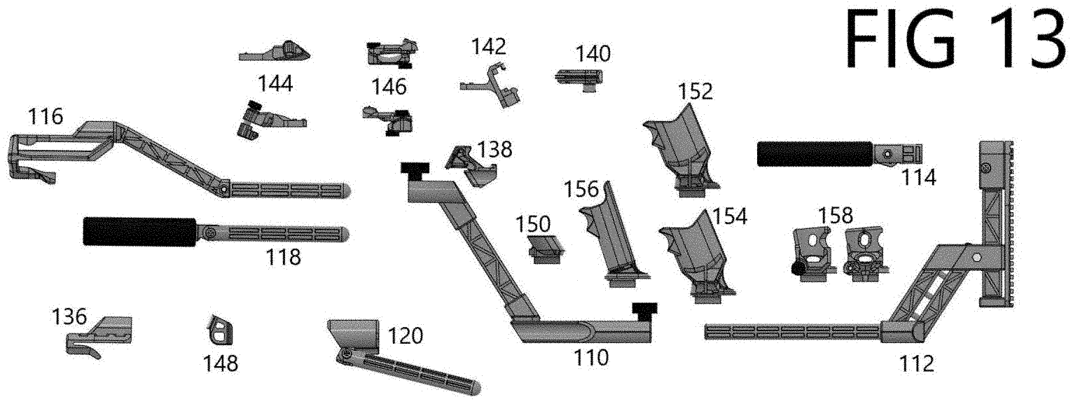

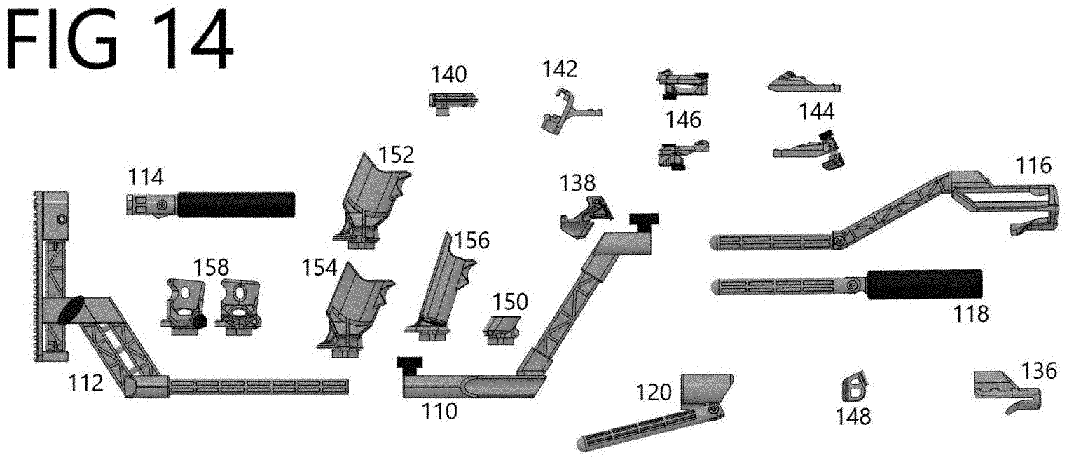

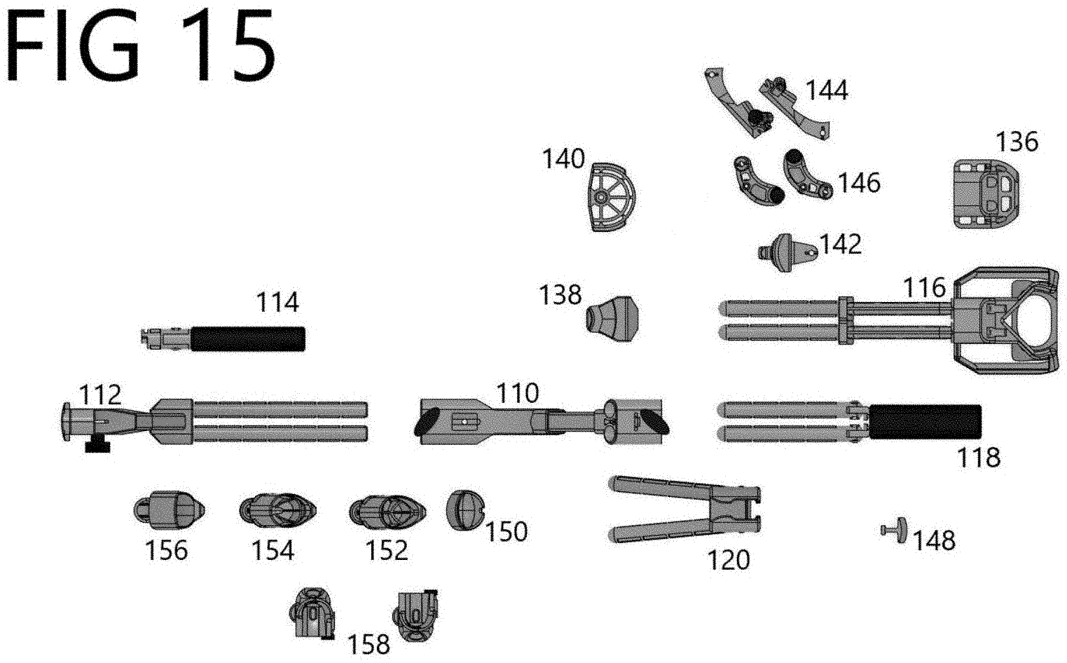

FIG. 11 illustrates an exploded bottom view of a set of parts of an example embodiment. FIG. 12 illustrates an exploded front view of a set of parts of an example embodiment. FIG. 13 illustrates an exploded left side view of a set of parts of an example embodiment. FIG. 14 illustrates an exploded right side view of a set of parts of an example embodiment. FIG. 15 illustrates an exploded top view of a set of parts of an example embodiment. The parts of an example embodiment shown in FIGS. 11 through 15 are described above in connection with FIGS. 8 and 10.

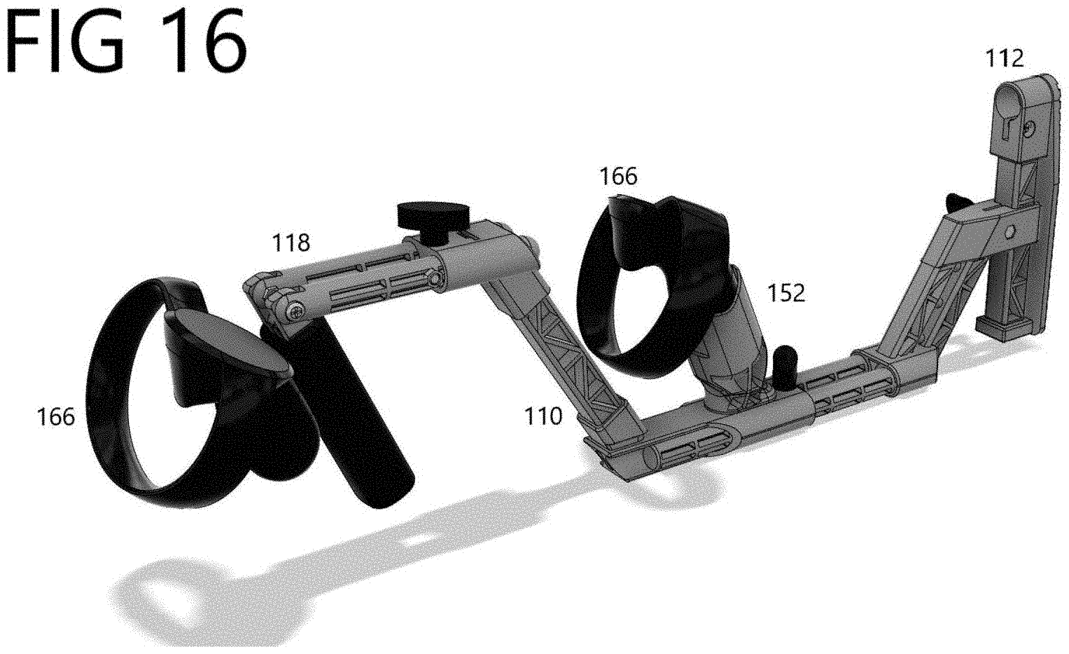

FIG. 16 illustrates an embodiment of an assembly in one of many versions with some of the parts of an example embodiment used as described above in combination with conventional D4-style VR controllers.

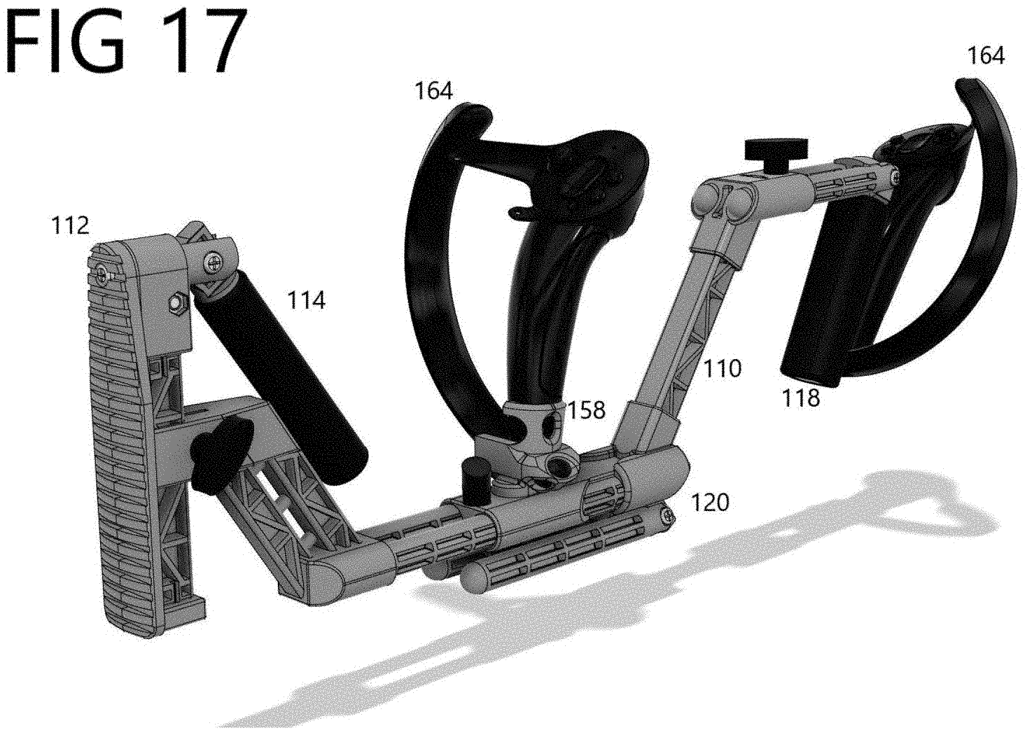

FIG. 17 illustrates an embodiment of an assembly in one of many versions with some of the parts of an example embodiment used as described above in combination with conventional C3-style VR controllers.

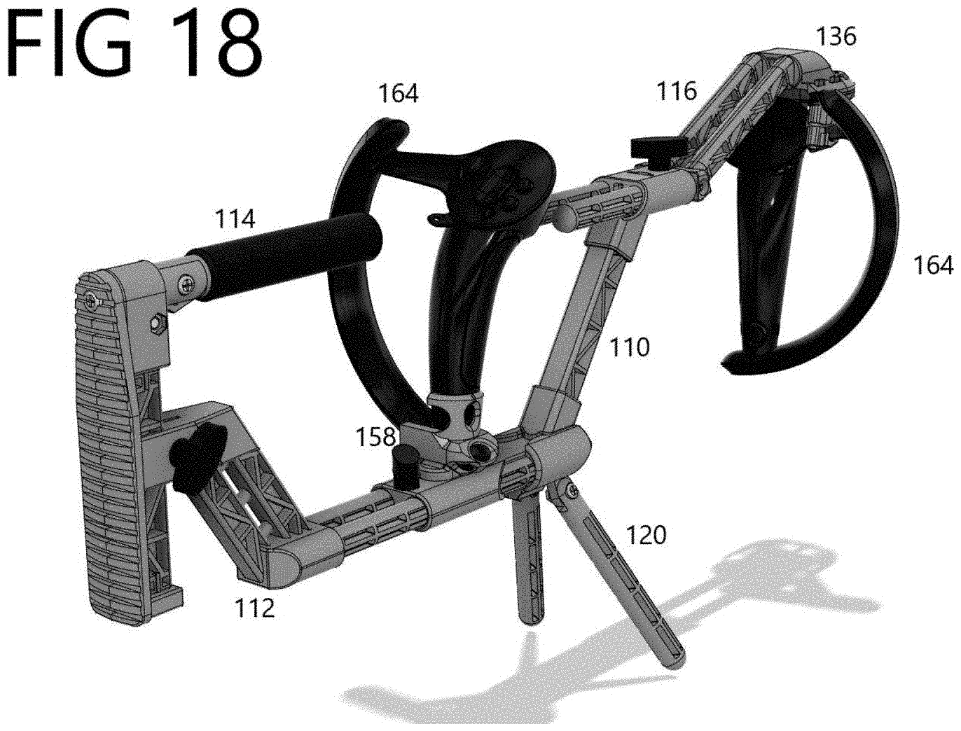

FIG. 18 illustrates an embodiment of another assembly in one of many versions with some of the parts of an example embodiment used as described above in combination with conventional C3-style VR controllers.

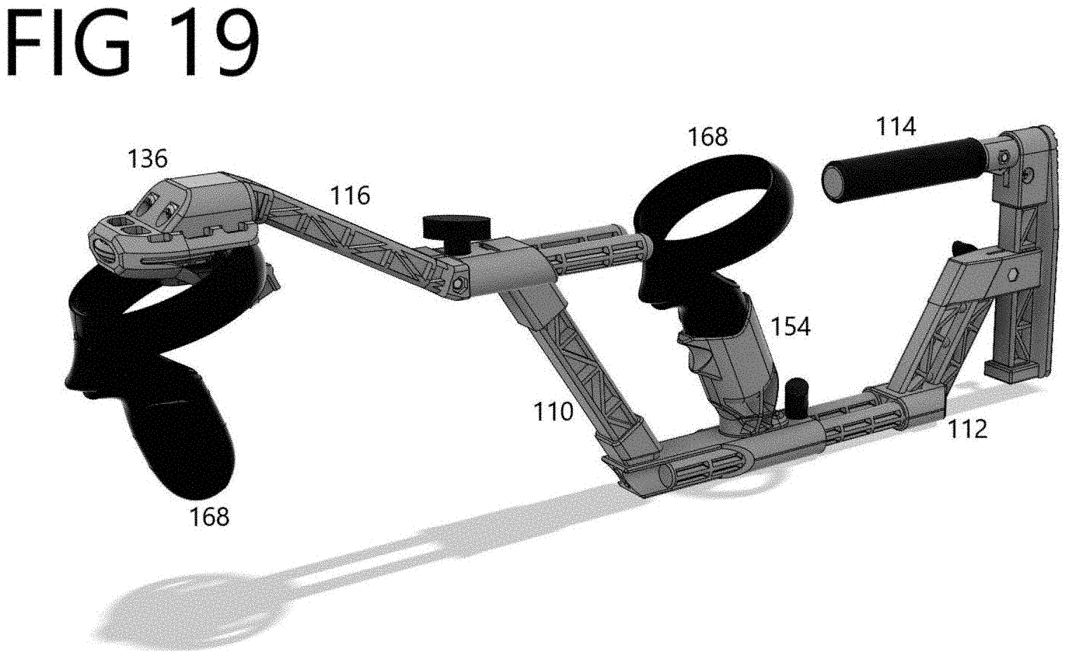

FIG. 19 illustrates an embodiment of an assembly in one of many versions with some of the parts of an example embodiment used as described above in combination with conventional E5-style VR controllers.

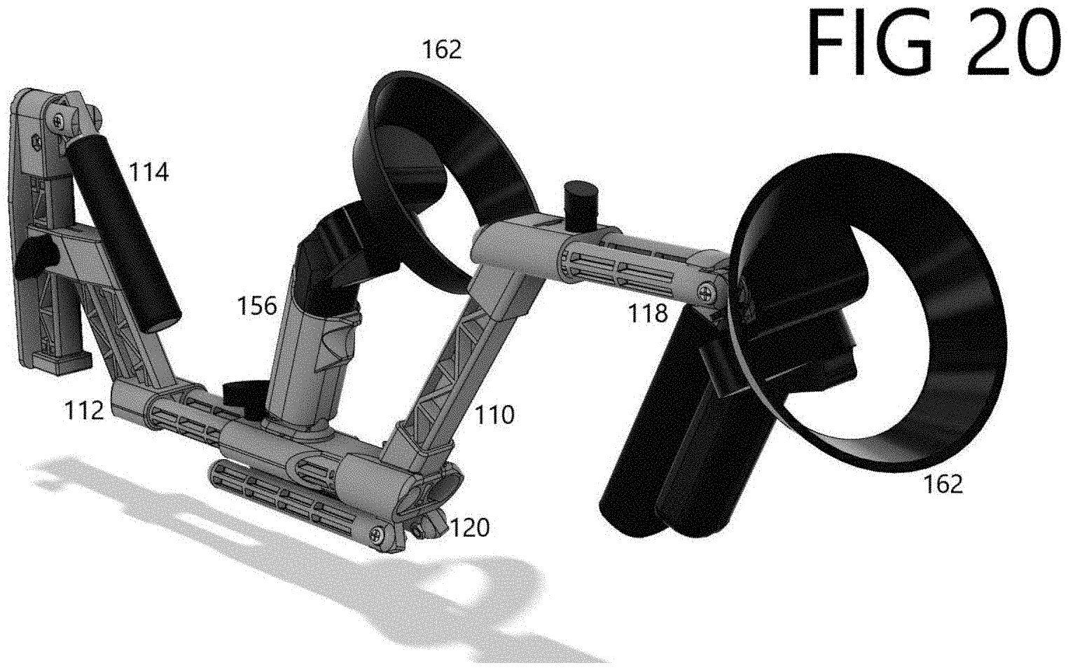

FIG. 20 illustrates an embodiment of an assembly in one of many versions with some of the parts of an example embodiment used as described above in combination with conventional B2-style VR controllers.

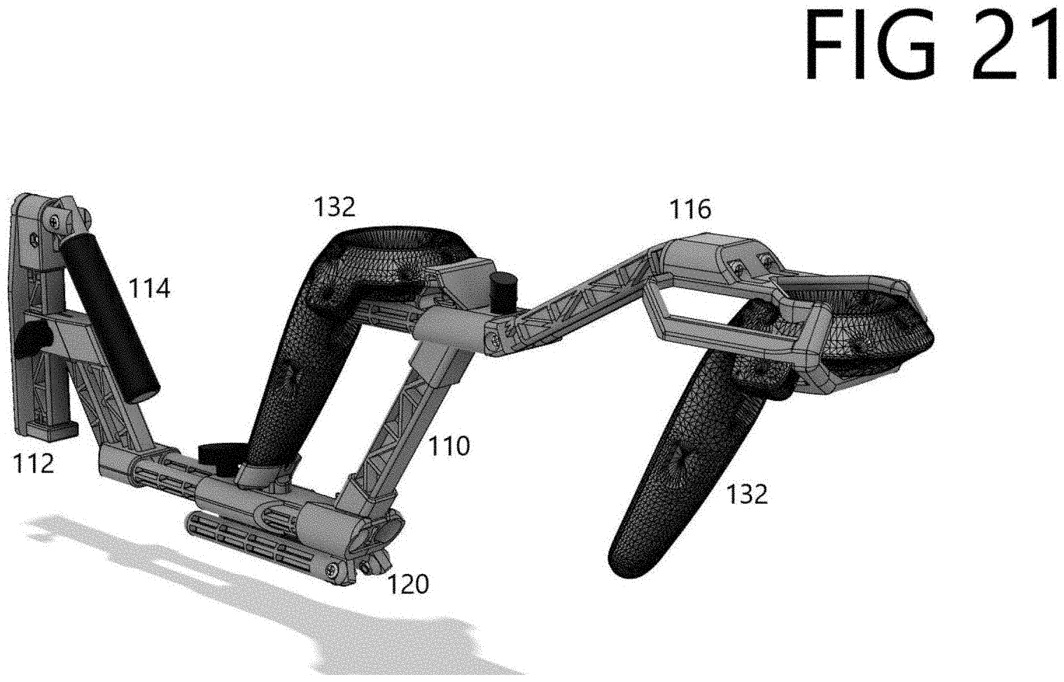

FIG. 21 illustrates an embodiment of an assembly in one of many versions with some of the parts of an example embodiment used as described above in combination with conventional A1-style VR controllers.

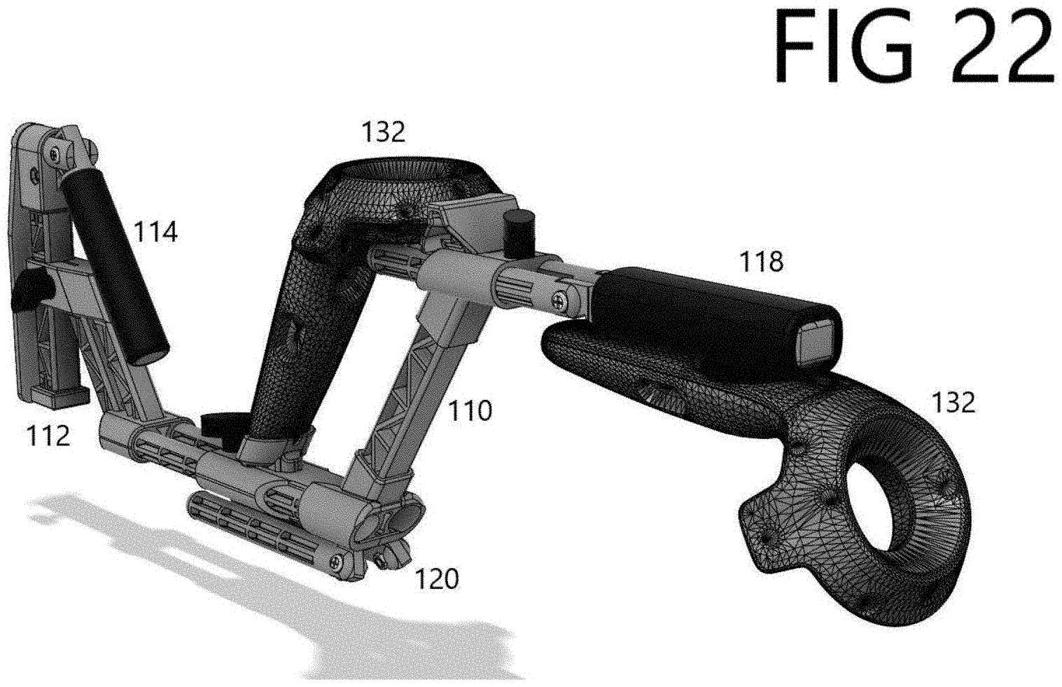

FIG. 22 illustrates an embodiment of another assembly in one of many versions with some of the parts of an example embodiment used as described above in combination with conventional A1-style VR controllers.

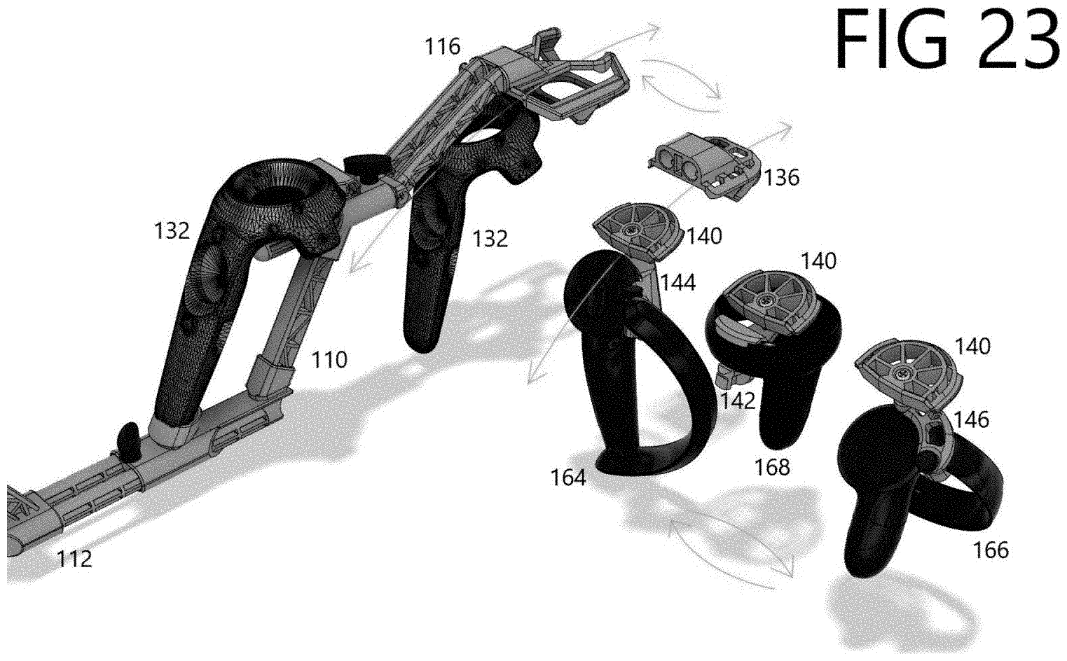

FIG. 23 illustrates various configurations of off-hand attachments and intended operation with fore-end cage components. In particular, FIG. 23 shows an alternate cage 136, an alternate cage plate for an off-hand VR controller lock 140, and alternate cage plate mounts 144 being used with a C3-style off-hand VR controller 164. FIG. 23 also shows an alternate cage plate for an off-hand VR controller lock 140 and an alternate cage plate mount 142 being used with an E5-style off-hand VR controller 168. FIG. 23 also shows an alternate cage plate for an off-hand VR controller lock 140 and an alternate cage plate mount 146 being used with a D4-style off-hand VR controller 166. In each case, the various example embodiments provide a modular, adjustable, and customizable frame simulating a rifle style appearance comprised of multiple components including, but not limited to, a receiver, butt-stock, barrels or fore-ends, bi-pod, chin rest, rails, and several types of adapters and mounts to accommodate different types of conventional VR controllers.

The main body of the example embodiments of the virtual reality gaming accessory or virtual reality training accessory (e.g., the receiver, the multi-barrel component, the cage barrel component, and the buttstock) can be made from many different materials, such as but not limited to, plastics, metals, wood, etc. The virtual reality gaming accessory or virtual reality training accessory can be made using various ways of manufacturing, such as but not limited to, three-dimensional (3D) printing, computer numerical control (CNC) machining, injection molding, laser cutting, hand crafting, etc. The cover of the multi-barrel 118 and the chin rest 114 can be made from foam to supply comfort and protection to the VR controller 132 and the user's chin.

The illustrations of embodiments described herein are intended to provide a general understanding of the structure of various embodiments, and they are not intended to serve as a complete description of all the elements and features of components and systems that might make use of the structures described herein. Many other embodiments will be apparent to those of ordinary skill in the art upon reviewing the description provided herein. Other embodiments may be utilized and derived, such that structural and logical substitutions and changes may be made without departing from the scope of this disclosure. The figures herein are merely representational and may not be drawn to scale. Certain proportions thereof may be exaggerated, while others may be minimized. Accordingly, the specification and drawings are to be regarded in an illustrative rather than a restrictive sense.

The description herein may include terms, such as “up”, “down”, “upper”, “lower”, “first”, “second”, etc. that are used only for descriptive purposes and not to be construed as limiting. The elements, materials, geometries, dimensions, and sequence of operations may all be varied for particular applications. Parts of some embodiments may be included in, or substituted for, those of other embodiments. While the foregoing examples of dimensions and ranges are considered typical, the various embodiments are not limited to such dimensions or ranges.

The Abstract is provided to allow the reader to quickly ascertain the nature and gist of the technical disclosure. The Abstract is submitted with the understanding that it will not be used to interpret or limit the scope or meaning of the claims. In the foregoing Detailed Description, various features are grouped together in a single embodiment for the purpose of streamlining the disclosure. This method of disclosure is not to be interpreted as reflecting an intention that the claimed embodiments have more features than are expressly recited in each claim. Thus, the following claims are hereby incorporated into the Detailed Description, with each claim standing on its own as a separate embodiment.

Although the disclosed subject matter has been described with reference to several example embodiments, it may be understood that the words that have been used are words of description and illustration, rather than words of limitation. Changes may be made within the purview of the appended claims, as presently stated and as amended, without departing from the scope and spirit of the disclosed subject matter in all its aspects. Although the disclosed subject matter has been described with reference to particular means, materials, and embodiments, the disclosed subject matter is not intended to be limited to the particulars disclosed; rather, the subject matter extends to all functionally equivalent structures, methods, and uses such as are within the scope of the appended claims.

What is claimed is:

1. A virtual reality firearm simulation accessory comprising:
a receiver including a first attachment mechanism for attaching a main hand virtual reality (VR) controller;
a multi-barrel component attachable to a forward end of the receiver, the multi-barrel component including a second attachment mechanism for attaching an off-hand VR controller; and
a buttstock attachable to a back end of the receiver.

2. The virtual reality firearm simulation accessory of claim 1 wherein the first attachment mechanism is a snap-in, wedge, or slide-in style attachment mechanism.

3. The virtual reality firearm simulation accessory of claim 1 wherein the receiver includes a hand controller support element to support a lower end of the main hand VR controller.

4. The virtual reality firearm simulation accessory of claim 1 wherein the receiver supports the main hand VR controller without obscuring sensors on the main hand VR controller.

5. The virtual reality firearm simulation accessory of claim 1 wherein the off-hand VR controller is attached to the multi-barrel component enabling a user to simultaneously hold the multi-barrel component and the off-hand VR controller.

6. The virtual reality firearm simulation accessory of claim 1 wherein the multi-barrel component can be extended to simulate a long gun.

7. The virtual reality firearm simulation accessory of claim 1 wherein the multi-barrel component can be folded downward to simulate a weapon with an under barrel attachment or vertical grip.

8. The virtual reality firearm simulation accessory of claim 1 wherein the multi-barrel component can be extended and retracted to simulate a sliding motion of a pump style shotgun.

9. The virtual reality firearm simulation accessory of claim 1 wherein the receiver, the multi-barrel component, and the buttstock are fabricated from a material from the group consisting of: plastic, metal, and wood.

10. The virtual reality firearm simulation accessory of claim 1 wherein the receiver, the multi-barrel component, and the buttstock are fabricated using a process from the group consisting of: three-dimensional (3D) printing, computer numerical control (CNC) machining, injection molding, laser cutting, and hand crafting.

11. A virtual reality firearm simulation accessory comprising:
a receiver including a first attachment mechanism for attaching a main hand virtual reality (VR) controller;
a cage barrel component attachable to a forward end of the receiver, the cage barrel component including a second attachment mechanism for attaching an off-hand VR controller; and
a buttstock attachable to a back end of the receiver.

12. The virtual reality firearm simulation accessory of claim 11 wherein the first attachment mechanism is a snap-in, wedge, or slide-in style attachment mechanism.

13. The virtual reality firearm simulation accessory of claim 11 wherein the receiver includes a hand controller support element to support a lower end of the main hand VR controller.

14. The virtual reality firearm simulation accessory of claim 11 wherein the receiver supports the main hand VR controller without obscuring sensors on the main hand VR controller.

15. The virtual reality firearm simulation accessory of claim 11 wherein the off-hand VR controller is attached to the cage barrel component using a clamping force.

16. The virtual reality firearm simulation accessory of claim 11 wherein the cage barrel supports the off-hand VR controller without obscuring sensors on the off-hand VR controller.

17. The virtual reality firearm simulation accessory of claim 11 wherein the receiver, the cage barrel component, and the buttstock are fabricated from a material from the group consisting of: plastic, metal, and wood.

18. The virtual reality firearm simulation accessory of claim 11 wherein the receiver, the cage barrel component, and the buttstock are fabricated using a process from the group consisting of: three-dimensional (3D) printing, computer numerical control (CNC) machining, injection molding, laser cutting, and hand crafting.
